(19) United States
(12) Patent Application Publication
(10) Pub. No.: US 2016/0117086 A1
(43) Pub. Date: Apr. 28, 2016

(54) METHOD OF SETTING USER INTERFACE OF REMOTE CONTROL SYSTEM

(71) Applicant: GRAND MATE CO., LTD., Taichung City (TW)

(72) Inventors: CHUNG-CHIN HUANG, Taichung City (TW); CHIN-YING HUANG, Taichung City (TW); HSIN-MING HUANG, Taichung City (TW); HSING-HSIUNG HUANG, Taichung City (TW); YEN-JEN YEH, Taichung City (TW); KUAN-CHOU LIN, Taichung City (TW); YU-CHIN TSAI, Taichung City (TW)

(21) Appl. No.: 14/520,739

(22) Filed: Oct. 22, 2014

(51) Int. Cl. G06F 3/0484; H04L 12/24; G06F 3/0486; G06F 3/0481; G06F 3/0482

(52) U.S. Cl. CPC G06F 3/04847; G06F 3/04817; G06F 3/0482; G06F 3/04842; G06F 3/0486; H04L 41/22

(57) ABSTRACT

A method of setting a user interface of a remote control system includes the following steps: A. set a first region on a screen of an electronic device; B. arrange at least a device icon at a predetermined position of the first region, wherein the device icon represents one of electric appliances to be controlled; and C. select the device icon in the first region to generate a control window for a user to operate to control the corresponding electric appliance. Using space compatibility and virtual reality, the user may be easy to recognize the electric appliance for control.

### BACKGROUND OF THE INVENTION

1. Technical Field

The present invention relates generally to a remote control system, and more particularly to a method of setting a user interface of a remote control system.

2. Description of Related Art

Most of electric appliances are equipped with a remote control for user to control the electric appliance without having to approach the electric appliance. Since there are a lot of electric appliances to be controlled, there are more and more remote controls at home. Sometime, we take a lot of time to find the very remote control because some remote controls look very much similar.

An improved remote control system is provided with an interpreter, which allows a user to control the electric appliances by an electronic device, such as laptop, desktop, smartphone, and tablet. The electronic device is connected to the interpreter through Internet, and then the interpreter transmits commands from the electronic device to the specified electric appliance. As a result, a plurality of the electric appliances could be controlled by a single electronic device.

However, all the controllable electric appliances are shown on the electronic device, so it might be difficult for the user to find the predetermined electric appliance on the electronic device while there are lots of electric appliances. If there are two electric appliances of the same model, the user would unable to tell which one is the exact electric appliance he/she wants to control on the electronic device. Try and error is the only way to find the exact electric appliance.

### BRIEF SUMMARY OF THE INVENTION

In view of the above, the primary objective of the present invention is to provide a method of setting a user interface of a remote control system, which shows the controllable electric appliances on the electronic device in an easier recognizable way.

The present invention provides a method of setting a user interface of a remote control system, wherein the remote control system includes an electronic device and a plurality of electric appliances to be controlled; the electronic device is connected to the electric appliances respectively to send the electric appliances control signals; and the electronic device has a screen. the method includes the following steps:

A. set a first region on the screen of the electronic device;

B. arrange at least a device icon at a predetermined position of the first region, wherein the device icon represents one of the electric appliances to be controlled; and

C. select the device icon in the first region to generate a control window for a user to operate to control the corresponding electric appliance.

Whereby, using space compatibility and virtual reality, the user may be easy to recognize the electric appliance for control.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a sketch diagram of the remote control system of a first preferred embodiment of the present invention;

FIG. 2 is a sketch diagram of the home page of the user interface of the first preferred embodiment of the present invention;

FIG. 3 is a sketch diagram of the confirm window of the user interface of the first preferred embodiment of the present invention;

FIG. 4 is a sketch diagram of the control window of the user interface of the first preferred embodiment of the present invention;

FIG. 5 is a sketch diagram of the user interface of a second preferred embodiment of the present invention; and

FIG. 6 is a sketch diagram of the user interface of a third preferred embodiment of the present invention.

### DETAILED DESCRIPTION OF THE INVENTION

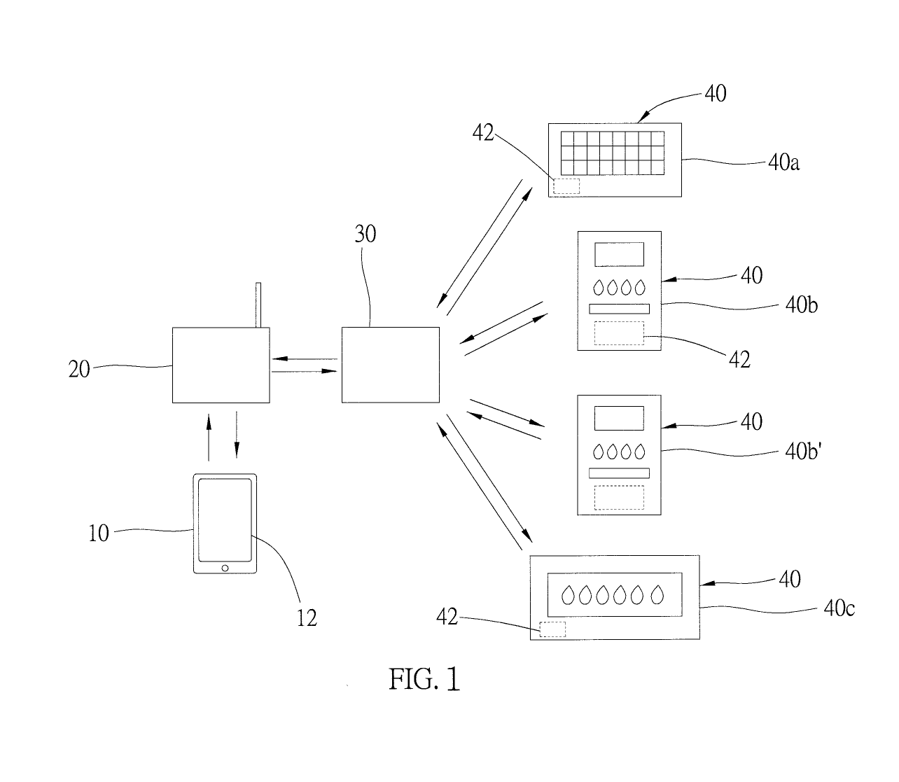

As shown in FIG. 1, a remote control system 1 of the first preferred embodiment of the present invention includes an electronic device 10, an access point (AP) 20, an interpreter 30, and a plurality of electric appliances 40. The electronic device 10 and the interpreter 30 are connected to the AP 20 though Wi-Fi signals for two-way communication. The interpreter 30 converts the Wi-Fi signals from the AP 20 into corresponding RF signals and transmits the RF signals to the electric appliances 40, and converts the RF signals from the electric appliances 40 into corresponding Wi-Fi signals and transmits the Wi-Fi signals to the AP 20. In the present embodiment, the electric appliances 40 includes an air conditioner 40a, two water heaters 40b, 40b′, and a fireplace 40c, which are located at different place of home. Each electric appliance 40 has a control unit 42 to receive the RF signals from the interpreter 30, and control the electric appliance 40 according to the commands in the RF signals. The control unit 42 transmits a running status signal, which is a RF signal including running data of some elements of the electric appliance 40, to the interpreter 30.

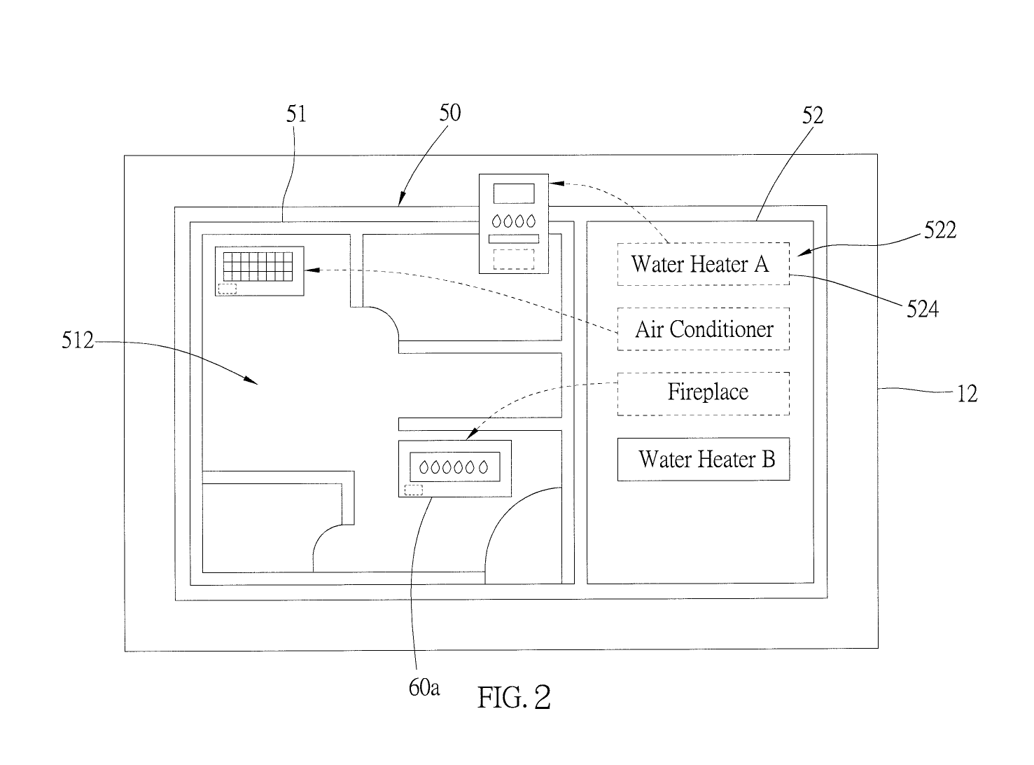

The electronic device 10 is a tablet in the present embodiment, which is connected to the electric appliances 40 through wireless connection to obtain identification codes 40 of the electric appliances 40. The electronic device 10 has a screen 12, which shows a user interface 20 (FIG. 2). The user interface 20 includes a first region 51 and a second region 52. In the present embodiment, a floor plan 512 is shown in the first region 51. The floor plan 512 is a layout of a real place, such as office or home. In practice, the floor plan 512 is drawn by a specific graphic software. The user may figure the floor plan by himself/herself, or ask a provider of the remote control system to make it, and the user only have to download the floor plan 512 from Internet.

The second region 52 shows a device list 522, which has a plurality of items 524, wherein each item 524 represents one of electric appliances 40, and the user may add, delete, or rename the items 524. Next, the user drags the items 524 of the device list 522 to the floor plan 512 in the first region 51, and drops them at specified positions where the real electric appliances 40 are located. As shown in FIG. 2, the item 524 of “Fireplace” in the device list 522 is dragged to the floor plan 512, and positioned at a predetermined position in a room.

In an embodiment, the item 524 is shown as a device icon after it is positioned in the floor plan 512. The device icon is an image of the electric appliance. In FIG. 2, the item 524 of “Fireplace” is converted into the device icon 60a of a fireplace in the floor plan 512. The device icons are generated according to the identification codes of the electric appliances 40, and in an embodiment, the device icons are designated by the user.

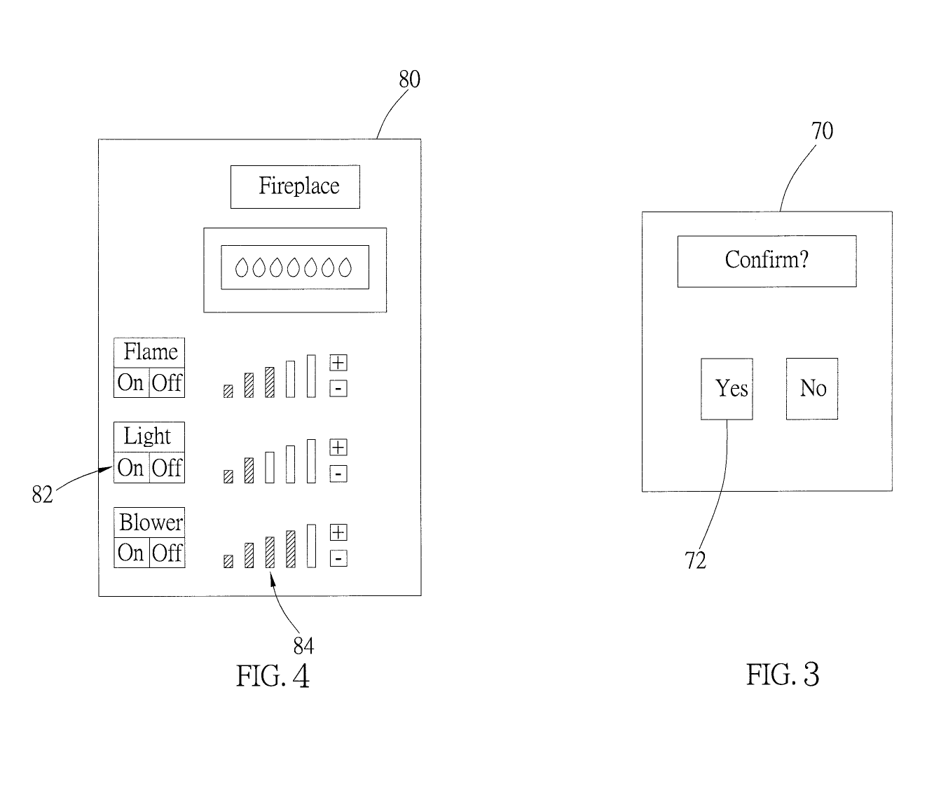

FIG. 3 shows a confirm window 70 which pops up on the screen 12 after the item 524 is positioned in the floor plan 512. If the user clicks “Yes” 72, the device icon 60a will be locked at where it is. Of course, the device icon 60a may be edited to change the location or the icon in the feature.

For the same steps, the items 524 of “Water Heater A” and the “Air Conditioner” of the device list 522 are dragged to different positions of the floor plan 512.

After all the electric appliances 40 for control are arranged in the floor plan 512, the user may control the electric appliances 40 by selecting the device icons 60a. For example, if the user wants to control the fireplace, he/she clicks the device icon 60a of fireplace, and then a control window 80 pops up for user to operate to control the real fireplace (FIG. 4). The control window 80 includes several control items 82, and the control items 82 include “Flame”, Light”, and “Blower”, which are the controllable elements of the fireplace. Each control item 82 is followed with an adjusting item 82 for user to change the magnitude of the control item 82. The user operates the adjusting item 82, and the electronic device generates a control signal accordingly, and sends it to the corresponding electric appliance 40 to control the electric appliance.

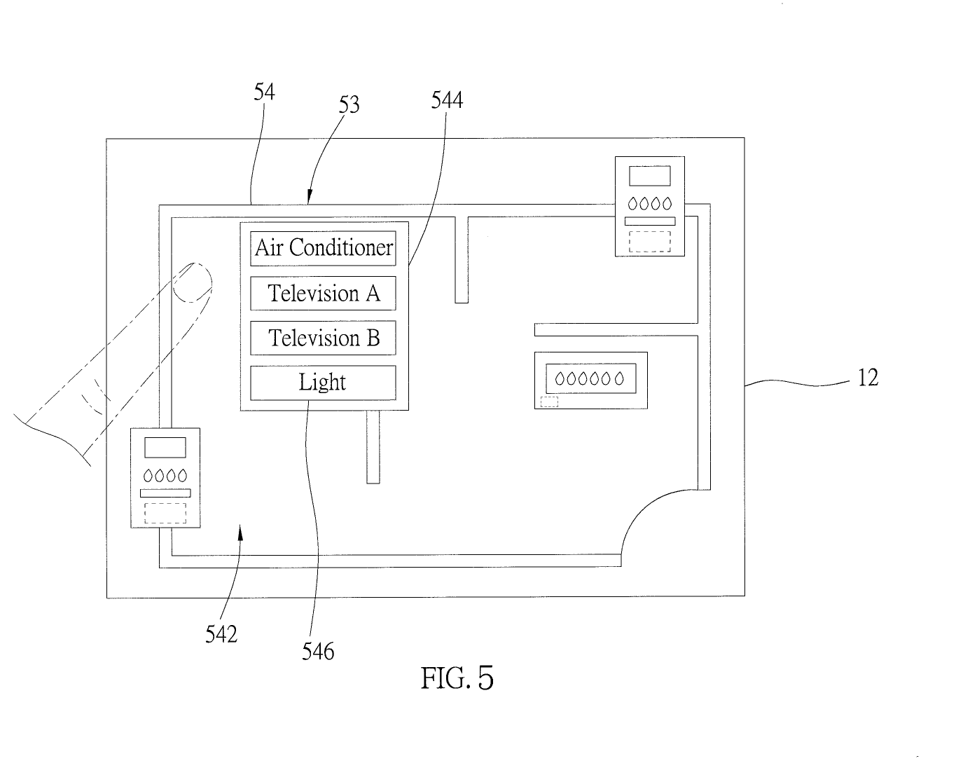

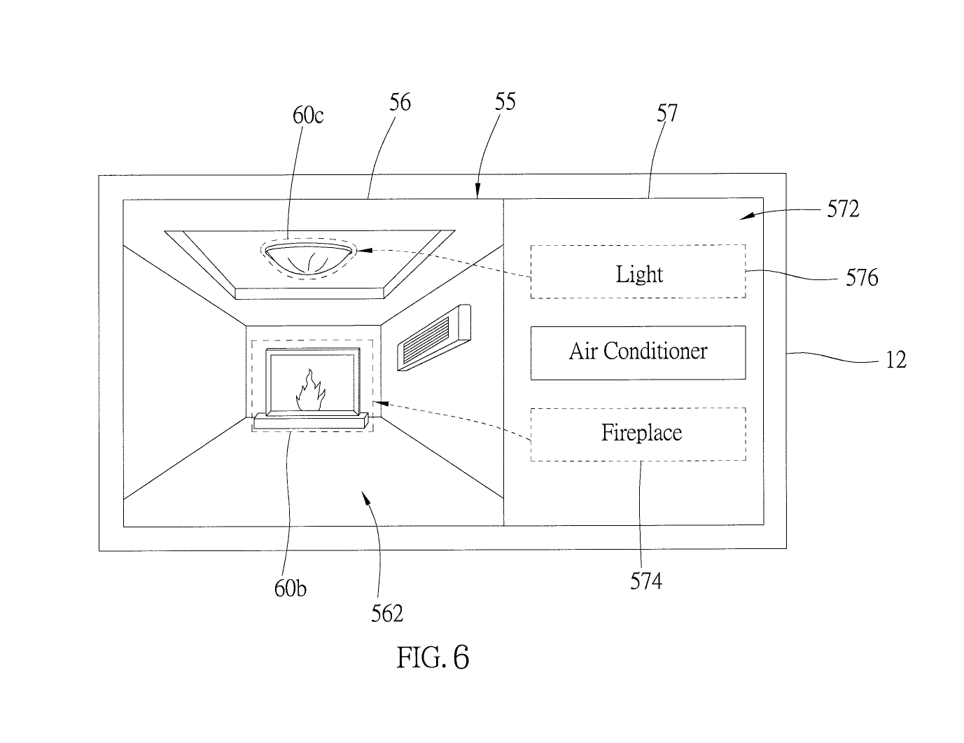

FIG. 5 shows a user interface 53 of the second preferred embodiment of the present invention, which is similar to the first preferred embodiment, except that the user interface 53 only has a first region 54, on which a floor plan 542 is shown. If the user touches any position of the floor plan 542, a device list 544 will pop up automatically. The same as above, the device list 544 has several items 546 of electric appliances, and the user may arrange the items 546 in the floor plan 542 as described above.

The same as the first preferred embodiment, a specified device icon, which represents the electric appliance to be controlled, in the floor plan 542 is selected, and the control window 80 will pops up for user to control the electric appliance.

As shown in FIG. 5, a user interface 55 of the third preferred embodiment of the present invention includes a first region 56 and a second region 57. A picture 562 is shown in the first region 56, and the picture 562 is taken from the real place where those electric appliances are placed. A device list 572 is shown in the second region, which includes items 574 of the electric appliances to be controlled. The same as above, the user drags the items 574 one by one to the picture 562. For example, drag the item 574 of “Fireplace” to a fireplace image in the picture 562, and then a setting region (a rectangular dot line) appears on the picture 562 at a position where the item 574 is dragged to. The setting region is adjustable for its size, and then the fireplace image becomes a device icon 60b in the picture 562.

The same as above, user may drag the item 576 of “Light” to a light image in the picture 562, and then the user is asked to draw a setting region on the picture 562. The user may depict the figure of the light image in the picture 562 to form the device icon 60c. Next, when the user clicks the device icon, a control window pops up for user to operate to control the corresponding electric appliance.

In conclusion, the present invention provides the user to arrange the electric appliances by himself/herself, and using space compatibility and virtual reality, the user may be easy to recognize the electric appliance for control.

It must be pointed out that the embodiments described above are only some preferred embodiments of the present invention. All equivalent structures which employ the concepts disclosed in this specification and the appended claims should fall within the scope of the present invention.

What is claimed is:

1. A method of setting a user interface of a remote control system, wherein the remote control system includes an electronic device and a plurality of electric appliances to be controlled; the electronic device is connected to the electric appliances respectively to send the electric appliances control signals; and the electronic device has a screen, the method comprising the steps of:
A. setting a first region on the screen of the electronic device;
B. arranging at least a device icon at a predetermined position of the first region, wherein the device icon represents one of the electric appliances to be controlled; and
C. selecting the device icon in the first region to generate a control window for a user to operate to control the corresponding electric appliance.

2. The method of claim 1, further comprising setting a second region on the screen in the step A; showing a device list in the second region, wherein the device list has at least an item, and each item represents one of the electric appliances to be controlled; dragging the item from the second region to the first region; and showing the device icon at a position where the item is dragged to.

3. The method of claim 1, further comprising clicking a predetermined position of the first region after the step A to generate a device list, wherein the device list has at least an item, and each item represents one of the electric appliances to be controlled; dragging the item from the device list to the first region; and showing the device icon at a position where the item is dragged to.

4. The method of claim 1, wherein the first region has a floor plan, and the device icon is shown on the floor plan.

5. The method of claim 4, wherein the floor plan is figured by a user.

6. The method of claim 4, wherein the floor plan is downloaded from Internet.

7. The method of claim 1, wherein the first region has a picture, and the device icon is shown on the picture.

8. The method of claim 7, further comprising showing a setting region on the picture, wherein the setting region becomes the device icon.

9. The method of claim 8, wherein a figure of the setting region is identical to an image of the picture.

10. The method of claim 1, further comprising locking the device icon at the predetermined position of the first region.
